(19) United States
(12) Patent Application Publication
(10) Pub. No.: US 2026/0276381 A1
(43) Pub. Date: Sep. 17, 2026

(54) METHOD AND SYSTEM FOR ESTIMATING AN ANGULAR RATE SENSOR BIAS

(71) Applicant: Robert Bosch GmbH, Stuttgart (DE)

(72) Inventor: Jing Liu, Bad Homburg Vor Der Hoehe (DE)

(21) Appl. No.: 19/560,344

(22) Filed: Mar. 9, 2026

(30) Foreign Application Priority Data
Mar. 12, 2025 (DE) 10 2025 109 484.5

(51) Int. Cl. G01C 19/00; G01C 25/00

(52) U.S. Cl. CPC G01C 19/005; G01C 25/00

(57) ABSTRACT

A gyroscope calibration system and method for estimating an angular rate sensor bias of a gyroscope sensor. The system includes: a filter unit which filters received gyroscope raw data to ascertain an estimated angular rate signal; a motion detection unit designed to calculate a moving average of a time derivative of the angular rate signal obtained from the filter unit and to identify a type of motion on the basis of the calculated moving average; an assignment unit designed to provide calibration parameters depending on the type of motion identified by the motion detection unit; and a calibration unit designed to estimate the angular rate sensor bias of the gyroscope sensor based on the calibration parameters assigned by the assignment unit to the calibration unit.

### CROSS REFERENCE

The present application claims the benefit under 35 U.S.C. § 119 of Germany Patent Application No. DE 10 2025 109 484.5 filed on Mar. 12, 2025, which is expressly incorporated herein by reference in its entirety.

### FIELD

The present disclosure relates to a system and an apparatus for estimating an angular rate bias of a gyroscope sensor or an angular rate sensor, and in particular to a method and a system that use a consistent gyroscope calibration algorithm for ascertaining an angular rate sensor bias of a gyroscope sensor in static and dynamic scenarios.

### BACKGROUND INFORMATION

Gyroscope sensors are commonly used in applications requiring information about angular velocity or orientation, such as AR/VR, navigation, robotics, etc. Normally, gyroscope sensors are factory preset; however, the sensor bias of the gyroscope sensor can be altered during installation of the gyroscope sensor (e.g., soldering process, PCB bending). The gyroscope sensor can also be referred to as an angular rate sensor.

Furthermore, real-time estimation of the gyroscope bias and the associated calibration of the gyroscope are essential since the sensor bias can change even after delivery, e.g., when there are fluctuations in ambient temperature. Therefore, estimating the bias of the gyroscope is of great importance not only in static but also in dynamic scenarios in order to compensate for distorted gyroscope signals and to acquire precise angular rate signals in real time as well as to obtain accurate orientation information.

U.S. Pat. No. 8,310,368 describes a gyroscope sensor for detecting a person's bite movement. The sensor measures the roll velocities of the hand, arm, wrist, or any combination of body parts of the forearm. The occurrence of movement when a person bites into food is detected when the positive roll velocity exceeds a threshold for the positive roll velocity and the negative roll velocity exceeds a threshold for the negative roll velocity, and when a time interval between the positive roll velocity and the negative roll velocity is in the range of 0.5 seconds to 10 seconds.

U.S. Pat. No. 9,958,470 describes a motion capture system for capturing the kinematic movements of the rigid segments of an articulated structure. The attitude unit of such a system consists of accelerometers, each of which has at least one measurement axis, magnetometers and gyroscopes. The pseudostatic state of the segments can be ascertained by thresholding the norm of the acceleration vector and the angle between the magnetic field vector and the acceleration vector. Furthermore, the orientation angle of the body segment and its first- and second-order derivatives form part of the state vector, which is predicted and updated by a Kalman filter.

Conventional systems either use gyroscope signals to detect a specific type of human motion (for example, biting into food), or they use a combination of accelerometers, gyroscopes, and magnetometers to detect the state of body segments, regardless of whether they are in a static or pseudostatic state.

Currently, there is no approach that detects a whole spectrum of bodily activities by using pure gyroscope signals.

Most conventional systems that deal with estimating gyroscope bias and calibrating gyroscope sensors concern static scenarios. However, some systems concern gyroscope calibration in dynamic scenarios.

China Patent Application No. CN 1 0341 1623 describes a magnetic sensor used to calibrate the scaling factor and bias of a gyroscope sensor. The calibration performance is tested in both static and dynamic scenarios.

China Patent Application No. CN 1 1201 3880 describes a MEMS gyroscope calibration method suitable for highly dynamic scenarios (i.e., high rotational speed, high overload) and aims to improve the calibration accuracy of the scaling factor and the transverse axis sensitivity of a gyroscope sensor. The true angular velocities are ascertained with high precision using a revolving stage.

Germany Patent Application DE 10 2004 041512 A1 describes a conventional method for calibrating a gyroscope in a positioning module within a moving system, in particular in a motor vehicle. The system relies on a positioning module which comprises at least one gyroscope for measuring the rotational speed of the moving system and at least one absolute position sensor, in particular a GPS receiver, for determining the direction of movement of the moving system. Since the system is dependent on at least one position sensor, a localization module (i.e., a GPS receiver) is used. A Kalman filter is used to calculate the calibration parameters of the vehicle.

U.S. Pat. No. 10,451,438 describes a method for ascertaining the orientation of a gyroscope as a function of time by integrating angular velocity signals. Predefined movements are used as true alignment values. A linear fit is performed to identify a bias component in the gyroscope signals, which is represented by the slope of the fitted line.

In the conventional methods, gyroscope calibration parameters are ascertained in dynamic scenarios on the basis of ground truth angular velocities obtained by a turntable, another type of sensor (e.g., magnetometer), GPS signals, or predetermined patterns. However, these conventional methods are based on reference angular velocity signals and have various disadvantages. For reference angular velocity signals obtained via a turntable or predefined patterns, it is difficult to update the gyroscope bias in real time, since a turntable or predefined motion patterns are not suitable for applications in the field. The signals from magnetometer sensors are susceptible to interference from additional magnetic sources in the environment and therefore exhibit distortions. The accuracy of the ground truth angular velocity signals based on GPS also depends on the visibility of the satellite signals.

### SUMMARY

According to a first aspect, the present disclosure provides a method for estimating an angular rate sensor bias of a gyroscope sensor (or angular rate sensor) comprising the steps of:
receiving gyroscope raw data from the gyroscope sensor; filtering the received gyroscope raw data through a filter to ascertain an estimated angular rate signal;
calculating a moving average of a time derivative of the estimated angular rate signal and identifying a type of motion of an object by means of a motion detection unit on the basis of the calculated moving average;
assigning calibration parameters to a calibration unit depending on the identified type of motion; and
estimating the angular rate sensor bias of the gyroscope sensor by means of the calibration unit on the basis of the assigned calibration parameters.

The object can be, for example, a person, an animal, a machine, or a portable device. The gyroscope sensor is attached to the object. There can also be a plurality of gyroscope sensors attached to the object.

The gyroscope raw data form angular rate sensor data of the gyroscope sensor or the angular rate sensor.

The method according to the present disclosure and the system according to the present disclosure provide a framework for calibrating gyroscope sensors or angular rate sensors, which is able not only to estimate the bias of the gyroscope sensor independently of prior knowledge of reference angle rates but also to update the angular rate sensor bias GSEN-BIAS in real time, particularly when the gyroscope sensor bias changes, for example when there are fluctuations in ambient temperature.

The method according to the present disclosure fills the gap in the development of a gyroscope calibration system that can perform angular rate bias estimation and the associated gyroscope calibration in real time over a spectrum of locomotion types, in particular over various human activities, in particular in the case of repetitive and periodic types of locomotion, for example walking or running.

The method and system according to the present disclosure is suitable not only for static but also for dynamic scenarios. Furthermore, according to the present disclosure, the angular rate sensor bias is updated using only raw gyroscope sensor signals or raw angular rate sensor signals as input, without requiring any reference angle rates.

In one possible embodiment of the method according to the present disclosure for estimating an angular rate sensor bias of a gyroscope sensor, the calibration unit generates calibrated gyroscope data in real time, taking into account the estimated angular rate sensor bias.

These calibrated gyroscope data can be evaluated by a subsequent data processing unit of a portable device or driver assistance system, providing more precise control responses due to the real-time calibration.

In one possible embodiment of the method according to the present disclosure for estimating an angular rate sensor bias of a gyroscope sensor, method for estimating a gyroscope sensor bias of a gyroscope sensor, the gyroscope sensor is exposed to successively changing different types of motion. The types of motion can include types of motion that are typical for the subsequent use of the gyroscope sensor in the field.

In one possible embodiment of the method according to the present disclosure for estimating an angular rate sensor bias of a gyroscope sensor, the types of motion to which the gyroscope sensor is exposed include a static rest state, a pseudostatic rest state, a dynamic motion and a highly dynamic motion.

In the static rest state, the gyroscope sensor is not moved. In the pseudostatic state, the gyroscope sensor is moved only minimally (e.g., holding the gyroscope sensor statically in the hand or on the wrist). In the dynamic state, the gyroscope sensor is moved such that the motion has a relatively small amplitude and is performed consistently (e.g., walking motion). In the highly dynamic state, the gyroscope sensor is moved such that the motion has a relatively large amplitude and is performed relatively inconsistently (e.g., running motion with varying running speed).

Furthermore, according to another aspect, the present disclosure provides a gyroscope calibration system for estimating an angular rate sensor bias of a gyroscope sensor, comprising:
a filter unit which filters received gyroscope raw data to ascertain an estimated angular rate signal;
a motion detection unit designed to calculate a moving average of a time derivative of the angular rate signal obtained from the filter unit and to identify a type of motion on the basis of the calculated moving average;
an assignment unit designed to provide calibration parameters depending on the type of motion identified by the motion detection unit; and
a calibration unit designed to estimate the angular rate sensor bias of the gyroscope sensor on the basis of the calibration parameters assigned by the assignment unit to the calibration unit.

In one possible embodiment of the gyroscope calibration system according to the present disclosure for estimating an angular rate sensor bias of a gyroscope sensor, the calibration unit is designed to generate calibrated gyroscope data in real time, taking into account the estimated angular rate sensor bias.

These real-time calibrated gyroscope data are provided to a data processing unit or controller to generate control signals for actuators.

In one possible embodiment of the gyroscope calibration system according to the present disclosure for estimating an angular rate sensor bias of a gyroscope sensor, the filter unit of the gyroscope calibration system has a Kalman filter.

According to a further aspect, the present disclosure provides a portable device having at least one gyroscope sensor, the gyroscope raw data or angular rate raw data of which are calibrated by means of the method for estimating an angular rate sensor bias of a gyroscope sensor according to the first aspect of the present disclosure. The portable device is, for example, a headphone.

According to a further aspect, the present disclosure provides a vehicle having at least one gyroscope sensor, the gyroscope raw data of which are calibrated by means of the method for estimating an angular rate sensor bias of a gyroscope sensor according to the first aspect of the present disclosure. The vehicle comprises a road vehicle, a watercraft, or an aircraft.

Further possible embodiments, developments and implementations of the present disclosure also include combinations not explicitly mentioned of features of the present disclosure described above or in the following relating to the exemplary embodiments. In particular, individual aspects as improvements or additions to the above embodiments and developments, insofar as is meaningful, can be added in any desired combination with one another to the basic form of the present disclosure, in view of the disclosure herein.

The present disclosure is explained in more detail below on the basis of the exemplary embodiments indicated in the figures.

### BRIEF DESCRIPTION OF THE DRAWINGS

FIG. 1 is a flowchart of a possible embodiment of the method according to the present disclosure.

FIG. 2 is a block diagram for schematically representing a possible embodiment of the calibration system according to the present disclosure.

FIG. 3 shows by way of example an area division used in the method and system according to the present disclosure.

FIG. 4A, 4B, 4C are signal diagrams for explaining the functioning of the method according to the present disclosure and of the calibration system according to the present disclosure.

The figures are intended to impart further understanding of the embodiments of the present disclosure. They illustrate embodiments and, in connection with the description, serve to explain principles and concepts of the present disclosure. Other embodiments and many of the mentioned advantages are apparent from the figures. The elements of the figures are not necessarily shown to scale relative to one another.

In the figures, identical, functionally identical, and identically acting elements, features and components are provided with the same reference signs in each case, unless stated otherwise.

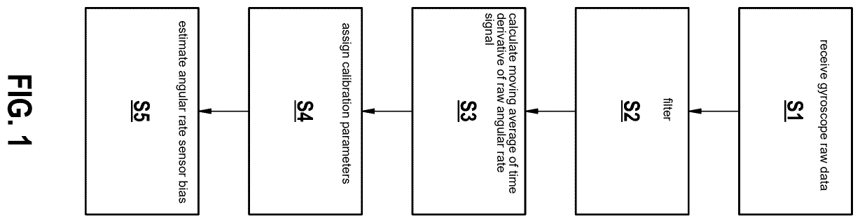

FIG. 1 is a flowchart of a possible embodiment of the method according to the present disclosure. The method shown is used to estimate an angular rate sensor bias GSEN-BIAS of a gyroscope sensor GSEN and comprises a plurality of steps S. In one possible embodiment, the gyroscope sensor GSEN is a MEMS gyroscope sensor. The gyroscope sensor GSEN can also be referred to as an angular rate sensor.

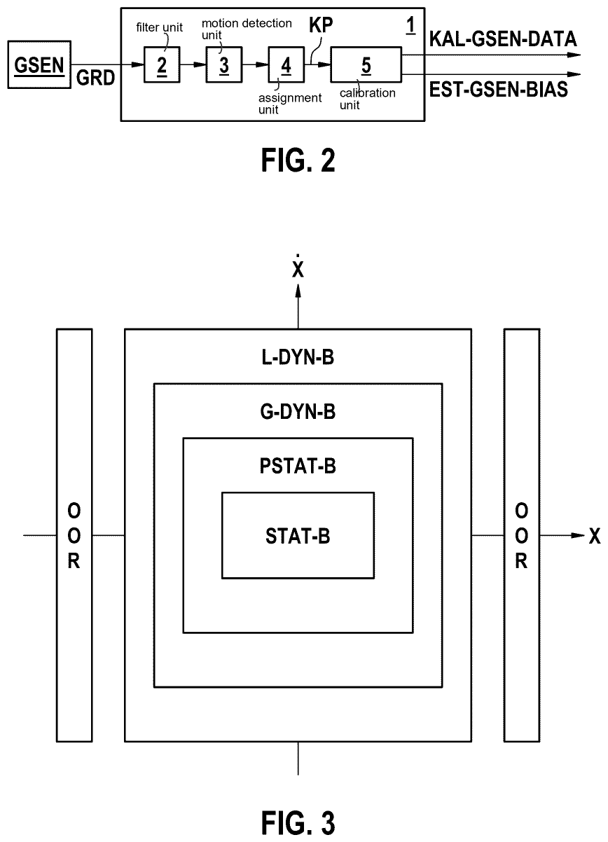

In a first step S1, gyroscope raw data GRD (or angular rate raw data) from the gyroscope sensor GSEN, which is preferably exposed to successively changing different types of motion, are received by the gyroscope calibration system 1 shown in FIG. 2.

In one possible embodiment, the types of motion to which the gyroscope sensor GSEN is exposed include a static rest state, a pseudostatic rest state, a dynamic motion and a highly dynamic motion.

In a further step S2, the gyroscope raw data GRD received from the gyroscope sensor GSEN are filtered by a filter unit 2 of the gyroscope calibration system 1 to ascertain an estimated angular rate signal. The filter unit 2 is preferably a Kalman filter.

In a further step S3, a moving average of a time derivative of the raw angular rate signal is calculated and a type of motion is identified on the basis of the calculated moving average by a motion detection unit 3 of the gyroscope calibration system 1.

In a further step S4, calibration parameters KP are assigned to a calibration unit 5 by an assignment unit 4 of the gyroscope calibration system depending on the type of motion identified in step S3.

In a further step S5, the angular rate sensor bias of the gyroscope sensor GSEN is estimated by the calibration unit 5 of the gyroscope calibration system on the basis of the calibration parameters KP assigned thereto.

Calibrated gyroscope data KAL-GSEN-DATA can be generated in real time by the calibration unit 5, taking into account the angular rate sensor bias GSEN-BIAS estimated in step S5, and output to a subsequent data processing unit for evaluation. The data processing unit has a processor for processing the obtained real-time calibrated gyroscope data KAL-GSEN-DATA, which in one possible embodiment generates control signals for actuators depending on the processed real-time calibrated gyroscope data KAL-GSEN-DATA.

FIG. 2 schematically shows a gyroscope calibration system 1, consisting of a filter unit 2, a motion detection unit 3, an assignment unit 4 for assigning calibration parameters KP and a gyroscope calibration unit 5. In one possible implementation, the calibration parameters KP can be read from a table stored in the assignment unit 4.

In a preferred embodiment, the input side of the gyroscope calibration system 1 has a Kalman filter 2 which, on the basis of the gyroscope raw data GRD received from the gyroscope sensor GSEN in step S1, makes an accurate estimate of a current system state (i.e., the angular rates) according to a Kalman filter algorithm implemented therein. The Kalman filter 2 of the gyroscope calibration system 1 is used to filter out interference, in particular noise, present in the gyroscope raw data GRD that the gyroscope calibration system 1 receives from the gyroscope sensor GSEN.

On the basis of the angular rates estimated by the Kalman filter 2 in step S2, the motion detection unit 3 of the gyroscope calibration system 1 first calculates the first-order derivative of the angular rate signals and then averages the calculated first-order derivative of the angular rate signals using a window to ascertain a moving average.

The range of averaged signals indicates the type of locomotion and, depending on the type of motion identified, appropriate calibration parameters KP are assigned to the gyroscope calibration unit 5 in step S4 by an assignment unit 4 of the gyroscope calibration system 1. Finally, in step S5, the gyroscope calibration unit 5 makes an estimate EST of the sensor offset or sensor bias EST-GSEN-BIAS of the gyroscope sensor GSEN and provides calibrated gyroscope data KAL-GSEN-DAT.

A key advantage of the gyroscope calibration system 1 shown in FIG. 2 is that the bias of the gyroscope sensor GSEN can be estimated not only by a single type of motion, but also by a combination of different types of motion. Furthermore, a change in the angular rate sensor bias GSEN-BIAS caused by temperature fluctuations between different types of motion can be detected, estimated and compensated for in real time.

The Kalman filter 2 is provided on the input side of the gyroscope calibration system 1 to accurately estimate the angular rates of the system, since the data measured by the IMU contain interference, in particular noise. The estimates of the unknown variables provided by Kalman filtering are generally more precise than those based only on a single measurement. The Kalman filter 2 works recursively on streams or sequences of noisy input data GRD to generate a statistically optimal estimate of the underlying system state.

The system dynamics can be described as a discrete linear system in the form of a state space:

$${x}_{k + 1} = {Fx}_{k} + {Bu}_{k} \qquad ( 1 )$$

where x_k is the state vector at time step k, which specifies the angular velocity of the system around the X, Y or Z axis. Since there are no control inputs for the system regarding the problem of the angular rate sensor bias GSEN-BIAS, u_k=0. A linear measurement model is also assumed, which has the following form:

$${z}_{k} = {Hx}_{k} \qquad ( 2 )$$

where z_k is a vector of measurements. In general, the structure of H depends on the type of sensor modalities and the state description. In the case of bias estimation of a gyroscope sensor GSEN or angular rate sensor, H is an identification matrix such that z_k=x_(k.)

It is possible to construct a state estimator and implement a Kalman filter 2 by combining this measurement model with the dynamics given by Eq. (1) and assuming noisy process and measurement models for the system.

$$\{ \begin{matrix}{x}_{k + 1} = {F}_{k} {x}_{k} + {B}_{k} {u}_{k} + {w}_{k} \\ {z}_{k} = {H}_{k} {x}_{k} + {v}_{k}\end{matrix} \qquad ( 3 )$$

where w and v are vectors representing the standard process and measurement noise variables respectively, which are assumed to be Gaussian processes with the covariances given by Q and R,

$$\{ \begin{matrix}w \sim N ( 0 , Q ) \\ v \sim N ( 0 , R )\end{matrix} \qquad ( 4 )$$

The Kalman filter 2 can be designed in two different phases: a prediction phase and an update phase.

During the prediction phase, the state estimate from the previous time step is used to create an estimate of the state in the current time step. This predicted state estimate is also referred to as an a priori state estimate, since it is an estimate of the state in the current time step, but does not contain any observational information from the current time step.

During the update phase, the current a priori prediction is combined with current observational information to refine the state estimate. This improved estimate is referred to as an a posteriori state estimate.

The regression formulae of a Kalman filter algorithm implemented in the Kalman filter 2 are as follows:

### Prediction Phase

### Predicted (a Priori) State Estimate

$${\hat{x}}_{k \vert k - 1} = {F}_{k} {\hat{x}}_{k - 1 \vert k - 1} + {B}_{k} {u}_{k - 1}$$

### Covariance of the Predicted (a Priori) Estimate

$${P}_{k \vert k - 1} = {F}_{k} {P}_{k - 1 \vert k - 1} {F}_{k}^{T} + {Q}_{k}$$

### Update Phase

### Optimal Kalman Gain

$${K}_{k} = {P}_{k \vert k - 1} {{H}_{k}^{T} ( {H}_{k} {P}_{k \vert k - 1} {H}_{k}^{T} + {R}_{k} )}^{- 1}$$

### Updated (a Posteriori) State Estimate

$${\hat{x}}_{k \vert k} = {\hat{x}}_{k \vert k - 1} + {K}_{k} ( {z}_{k} - {H}_{k} {\hat{x}}_{k \vert k - 1} )$$

### Updated (a Posteriori) Covariance Estimate

$${P}_{k \vert k} = ( I - {K}_{k} {H}_{k} ) {P}_{k \vert k - 1}$$

The consistent gyroscope calibration algorithm used in the gyroscope calibration system 1 according to the present disclosure for gyroscope bias estimates is suitable not only for static but also for dynamic scenarios. The gyroscope calibration system 1 according to the present disclosure can also be referred to as an angular rate sensor calibration system 1.

Therefore, it is important that the consistent gyroscope calibration algorithm can detect system states. For this purpose, angular rate signals (x) and the first-order derivative of angular rate signals (x, angular acceleration) are used as a key identifier for dividing the entire working range into different limit ranges.

The different ranges include a static range STAT-B, a pseudostatic range PSTAT-B and a dynamic range DYN-B, which in turn can be further subdivided into a dynamic walking range G-DYN-B and a highly dynamic running range L-DYN-B, but is not limited to walking and running/jogging activities (see FIG. 3). Raw or unprocessed angular rate signals GRD contain noise, and therefore calculating the first-order derivative of the angular rate signals amplifies the noise. Therefore, preferably the first-order time derivative of the angular rate signal x is averaged using a moving time window to calculate a moving average, thereby reducing the influence of noise on the first-order derivative of the angular rate signal.

The size of the individual ranges can be adjusted by setting threshold values. In particular, the size of the static range STAT-B can be adjusted with respect to the angular rate sensor bias calibration in the static state for different user end calibration performances. The larger the static range, the shorter the calibration time and the higher the calibration accuracy.

One advantage of providing such a motion-free calibration range is that during the calibration of a gyroscope sensor GSEN in static scenarios, other dynamic activities acting on the sensor board of the gyroscope sensor GSEN do not affect the estimated gyroscope bias EST-GSEN-BIAS and the associated rated accuracy level AL, since the estimates of the gyroscope bias EST-GSEN-BIAS and the rating of the accuracy level AL are not updated outside the static range.

FIG. 3 shows by way of example an area division with (x, x⁻). Angular rate signals (x) and the first-order derivative of angular rate signals (*, angular acceleration) divide the entire working range into different limit ranges, including the static range STAT-B, the semi-static range PSTAT-B and a dynamic range DYN-B (e.g., walking range G-DYN-B, running range L-DYN-B). OOR (out-of-range) in the schematic representation shown in FIG. 3 denotes the range outside a range of the gyroscope.

Depending on the type of motion ascertained by the motion detection unit 3, the appropriate calibration parameters KP are assigned to the gyroscope calibration unit 5.

The calibration algorithm performed by the gyroscope calibration unit 5 of the gyroscope calibration system 1 is, in one possible embodiment, as follows:

$$\begin{matrix}{ω}_{b} := ( I - α ) {ω}_{b} + {αω}_{e} \\ {ω}_{c} = {ω}_{m} - {ω}_{b}\end{matrix}$$

where the vector ω_b represents the calibration angular velocities and is updated in real time during the calibration, where ω_m represents the raw measurement data GRD obtained from the gyroscope sensor GSEN, where
ω_e represents the estimated angular rate signals obtained from the filter,
and where ω_c denotes the calibrated angular velocities.
α denotes a weighting value matrix which determines the extent to which the updated output patterns ω_b depend on the input measurement patterns ω_m and the previous outputs. In this case, the elements in the weighting value matrix & have small values, which means that the previous outputs contribute more to the updated calibration angular velocities, while the measurements are not reliable and therefore contribute less.

In one possible embodiment, the gyroscope calibration unit 5 can have two accuracy levels AL: AL0 and AL3. The accuracy level AL0 means that the gyroscope calibration is not yet complete, while the accuracy level AL3 means that the gyroscope calibration is complete and the deviation of the ascertained sensor offset is below a threshold of, for example, 0.05 degrees/s, so that the calibrated gyroscope data KAL-GSEN-DATA can be used for other applications.

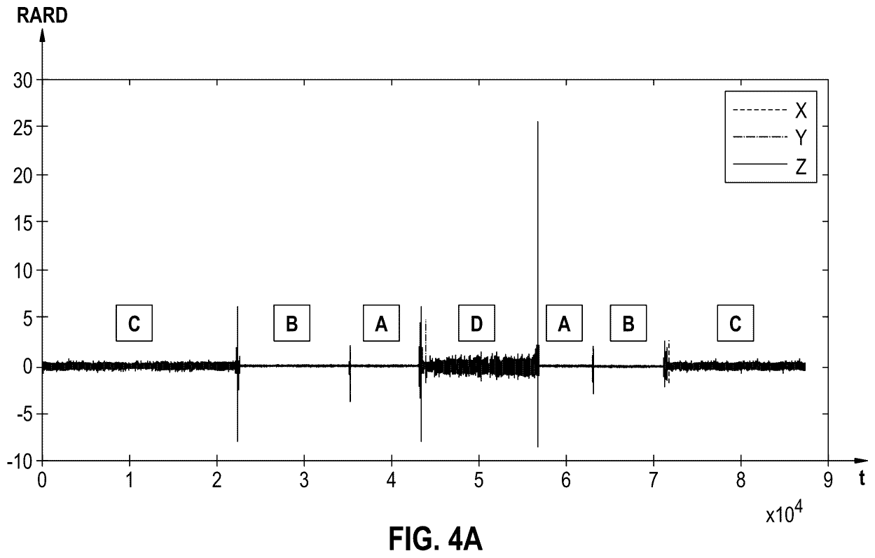

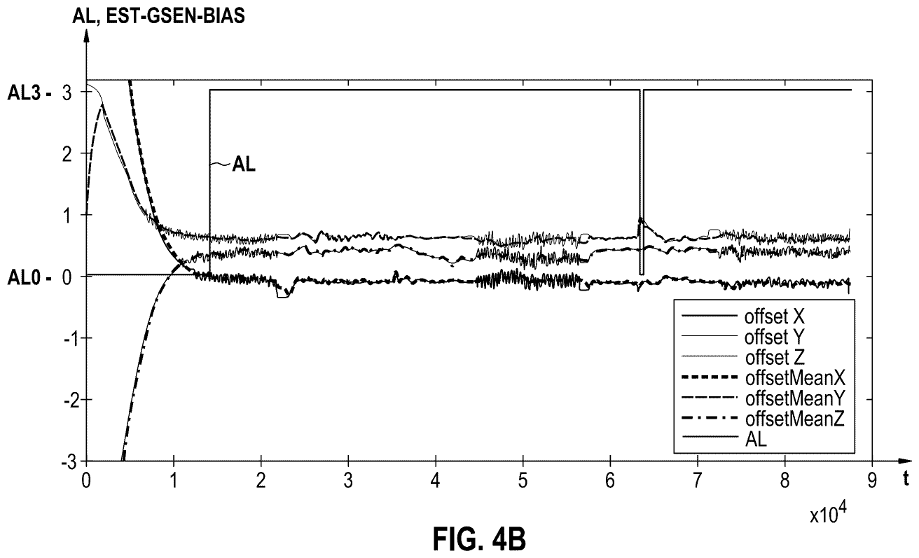

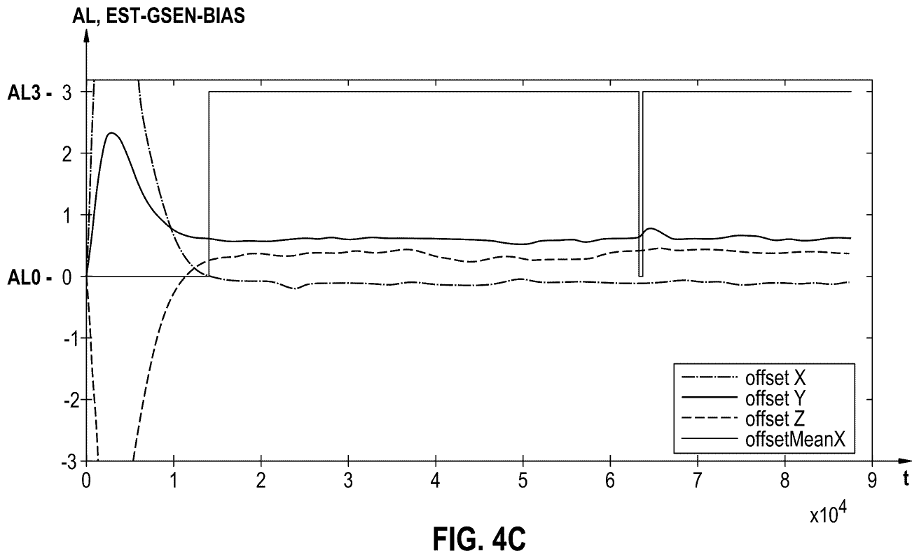

FIGS. 4A, 4B, and 4C show how the angular rate sensor bias GSEN-BIAS of a gyroscope sensor GSEN is estimated using the gyroscope calibration method according to the present disclosure on the basis of a range of human activities. These activities include holding the gyroscope sensor GSEN in a person's hand (pseudostatically) as well as while the person is walking and jogging.

FIGS. 4A, 4B, and 4C show calibration results for one possible embodiment of the gyroscope calibration method according to the present disclosure.

FIG. 4A shows a raw angular velocity signal measured by a MEMS gyroscope sensor GSEN. FIG. 4A shows the raw angular rate data RARD measured by a gyroscope sensor GSEN for different types of motion A, B, C, D. A test subject first walks (part C in FIG. 4A), then holds the gyroscope sensor GSEN in their hand (part B in FIG. 4A), then places the gyroscope sensor GSEN on a rigid surface to hold it statically (part A in FIG. 4A), and then goes jogging (part D in FIG. 4A). During data collection while walking and jogging, the sensor board of the gyroscope sensor GSEN is firmly secured to the test subject's head with an elastic band, so that the sensor board of the gyroscope sensor GSEN cannot move relative to the test subject's head during walking and jogging/running.

FIG. 4B shows real-time estimates of the gyroscope sensor bias EST-GSEN-BIAS and a calibration completion time. The accuracy level AL reaches accuracy level AL3 after approximately 1 to 2 minutes of walking (type of motion C). After a few more minutes, the accuracy level AL drops to accuracy level AL0 during the transition from a static state to a pseudostatic state and then rises again to accuracy level AL3.

Since human walking and running behavior is periodic and cyclical, the raw data of the angular rate fluctuate, and therefore so does the estimated angular rate sensor bias EST-GSEN-BIAS. To counteract the oscillations, a moving average window is therefore preferably used to smooth the estimated gyroscope bias EST-GSEN-BIAS; see offsetMeanX, offsetMeanY and offsetMeanZ in FIG. 4B. The state transitions (e.g., transitions between types of motion A, B, C, and D) can cause jumps in the estimated gyroscope bias EST-GSEN-BIAS. In one possible embodiment, the problem of abrupt gyroscope bias or angular rate sensor bias due to state transitions is eliminated by not updating the gyroscope bias accordingly when the angular velocity values in the raw data exceed a predefined threshold.

FIG. 4C shows averaged gyroscope bias estimates EST-GSEN-BIAS. The estimated gyroscope bias can be further averaged to obtain smoothed results, as can be seen in FIG. 4C.

The gyroscope sensor GSEN shown in FIG. 2 is located on a sensor board and can be integrated into a portable device, for example a smartphone, headphones or a driver assistance system of a vehicle.

Although the present disclosure has been completely described above with reference to preferred exemplary embodiments, it is not limited thereto, but can be modified in many ways.

What is claimed is:

1. A method for estimating an angular rate sensor bias of a gyroscope sensor, the method comprising the following steps:
receiving gyroscope raw data from the gyroscope sensor;
filtering the received gyroscope raw data through a filter to ascertain an estimated angular rate signal;
calculating a moving average of a time derivative of the estimated angular rate signal and identifying a type of motion of an object using a motion detection unit based on the calculated moving average;
assigning calibration parameters to a calibration unit depending on the identified type of motion; and
estimating the angular rate sensor bias of the gyroscope sensor using the calibration unit based on the assigned calibration parameters.

2. The method according to claim 1, further comprising:
generating, by the calibration unit, calibrated gyroscope data in real time, taking into account the estimated angular rate sensor bias.

3. The method according to claim 1, wherein the gyroscope sensor is exposed to successively changing different types of motion.

4. The method according to claim 3, wherein the types of motion to which the gyroscope sensor is exposed include a static rest state, a pseudostatic rest state, a dynamic motion, and a highly dynamic motion.

5. A gyroscope calibration system for estimating an angular rate sensor bias of a gyroscope sensor, the gyroscope calibration system comprising:
a filter unit configured to filter received gyroscope raw data to ascertain an estimated angular rate signal;
a motion detection unit configured to calculate a moving average of a time derivative of the estimated angular rate signal obtained from the filter unit and to identify a type of motion based on the calculated moving average;
an assignment unit configured to provide calibration parameters depending on the type of motion identified by the motion detection unit; and
a calibration unit configured to estimate the angular rate sensor bias of the gyroscope sensor based on the calibration parameters assigned by the assignment unit.

6. The gyroscope calibration system according to claim 5, wherein the calibration unit is configured to generate calibrated gyroscope data in real time, taking into account the estimated angular rate sensor bias.

7. The gyroscope calibration system according to claim 5, wherein the filter unit includes a Kalman filter.

8. A portable device, comprising:
at least one gyroscope sensor, wherein gyroscope raw data from the at least one gyroscope sensor are calibrated using a method for estimating an angular rate sensor bias of at least one gyroscope sensor, the method including:
receiving the gyroscope raw data from the at least one gyroscope sensor,
filtering the received gyroscope raw data through a filter to ascertain an estimated angular rate signal,
calculating a moving average of a time derivative of the estimated angular rate signal and identifying a type of motion of an object using a motion detection unit based on the calculated moving average,
assigning calibration parameters to a calibration unit depending on the identified type of motion, and
estimating the angular rate sensor bias of the at least one gyroscope sensor using the calibration unit based on the assigned calibration parameters.

9. A vehicle, comprising:
at least one gyroscope sensor, wherein gyroscope raw data from the at least one gyroscope sensor being calibrated or dynamically recalibrated using a method for estimating an angular rate sensor bias of the at least one gyroscope sensor, the method including:
receiving the gyroscope raw data from the at least one gyroscope sensor,
filtering the received gyroscope raw data through a filter to ascertain an estimated angular rate signal,
calculating a moving average of a time derivative of the estimated angular rate signal and identifying a type of motion of an object using a motion detection unit based on the calculated moving average,
assigning calibration parameters to a calibration unit depending on the identified type of motion, and
estimating the angular rate sensor bias of the at least one gyroscope sensor using the calibration unit based on the assigned calibration parameters.
